(19) United States
(12) Patent Application Publication
(10) Pub. No.: US 2010/0146157 A1
(43) Pub. Date: Jun. 10, 2010

(54) MULTI-RADIO INTERFACING AND DIRECT MEMORY ACCESS BASED DATA TRANSFERRING METHODS AND SINK NODE FOR PERFORMING THE SAME IN WIRELESS SENSOR NETWORK

(75) Inventors: Byeong Cheol CHOI, Daejeon-city (KR); In Hwan Lee, Daejeon-city (KR); Byung Bog Lee, Daejeon-city (KR); Myung Nam Bae, Daejeon-city (KR); Nae Soo Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/568,105

(22) Filed: Sep. 28, 2009

(30) Foreign Application Priority Data
Dec. 10, 2008 (KR) 10-2008-0125124

(51) Int. Cl. G06F 13/28

(52) U.S. Cl. 710/22

(57) ABSTRACT

Provided are a method of mediating a plurality of radio frequency (RF) transceivers, which is performed in a sink node in order to perform multi-radio interfacing between the sink node and a plurality of sensor nodes in a wireless sensor network (WSN), and a direct memory access (DMA) based data transfer method.

### CROSS-REFERENCE TO RELATED PATENT APPLICATION

This application claims the benefit of Korean Patent Application No. 10-2008-0125124, filed on Dec. 10, 2008, in the Korean Intellectual Property Office, the disclosure of which is incorporated herein in its entirety by reference.

### BACKGROUND OF THE INVENTION

1. Field of the Invention

The present invention relates to a sink node that is closely coupled to a gateway connected to an Internet protocol (IP) core network and is a start point and an end point of wireless communication between a plurality of sensor nodes in a wireless sensor network (WSN), and more particularly to, a method of mediating between a plurality of transceivers of a sink node, a direct memory access (DMA) based data transfer method, and a sink node for performing the methods in order to perform multi-radio interfacing in a WSN.

2. Description of the Related Art

A conventional sink node operates a single antenna so that a microcontroller and a radio frequency (RF) transceiver may be directly connected with each other via a serial peripheral interface (SPI) bus. The number of RF transceivers connected to the antenna is limited according to the number of SPI buses supported by the microcontroller.

### SUMMARY OF THE INVENTION

The present invention provides a method of mediating between a plurality of transceivers and a serial peripheral interface (SPI) bus by using a direct memory access (DMA) function of a microcontroller in order to easily transmit and receive data between the transceivers and a microcontroller unit (MCU) when a sink node of a wireless sensor network (WSN) uses a plurality of antennas to operate multi-personal area networks (PAN), thereby increasing a data transfer bandwidth, reducing data delay and loss, and easily increasing the number of antennas.

According to an aspect of the present invention, there is provided a direct memory access (DMA) based data transmitting and receiving apparatus of a sink node, the apparatus including: a serial peripheral interface (SPI) bus controller controlling receiving, through a plurality of transceivers, data from each of a plurality of sub networks included in a sensor network; and a DMA controller storing the received data and scheduling the stored data to a microcontroller according to a determined order.

According to another aspect of the present invention, there is provided a DMA based data transmitting and receiving apparatus of a sink node, the apparatus including: a DMA controller storing data received from a microcontroller and scheduling the stored data to a plurality of transceivers that communicate with a sensor network that is divided into a plurality of sub networks; and an SPI bus controller controlling the scheduled data to be transmitted to one of the plurality of transceivers.

According to another aspect of the present invention, there is provided a DMA based data transmitting and receiving apparatus of a sink node, the sink node including: a receiving unit storing data received, through a plurality of transceivers, from each of a plurality of sub networks of a sensor network and scheduling the data to a microcontroller; and a transmitting unit storing data received from the microcontroller and scheduling the data to a corresponding transceiver of the plurality of transceivers.

According to another aspect of the present invention, there is provided a DMA based data transmitting and receiving apparatus of a sink node, the apparatus including: an SPI bus controller interfaced with a plurality of transceivers communicating, via an SPI bus, with a plurality of sub networks included in a sensor network including a plurality of sensor nodes and controlling transmitting and receiving of data through the plurality of transceivers according to a bus control signal; and a DMA controller storing data received from the plurality of sub networks, scheduling the stored data to a microcontroller, storing data received from the microcontroller, and scheduling the stored data to the plurality of transceivers.

According to another aspect of the present invention, there is provided a DMA based data transferring method performed by a sink node, the method including: receiving, through a plurality of transceivers, data from each of a plurality of sub networks include in a sensor network; and storing the received data and scheduling the stored data to a microcontroller according to a determined order.

According to another aspect of the present invention, there is provided a DMA based data transferring method performed by a sink node, the method including: storing data received from a microcontroller and scheduling the stored data to a plurality of transceivers that communicate with a sensor network that is divided into a plurality of sub networks; and controlling the scheduled data to be transmitted to one of the plurality of transceivers.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional personal area network (PAN) operating structure of a sink node including a single antenna;

FIG. 2 illustrates a multi-PAN operation structure of a sink node including multiple antennas, according to an embodiment of the present invention;

FIG. 3 is a schematic block diagram of a sink node including a plurality of antennas for transmitting and receiving radio frequency (RF) data, according to an embodiment of the present invention;

FIG. 4 is a block diagram of a direct memory access (DMA) controller and a serial peripheral interface (SPI) bus controller that are interfaced with a microcontroller, according to an embodiment of the present invention;

FIG. 5 is a diagram for explaining a mediating method with respect to a status of a first-in first-out (FIFO) buffer, according to an embodiment of the present invention; FIG. 6 is a diagram for explaining a memory mapping relationship between a DMA memory and SPI reception buffers, according to an embodiment of the present invention;

FIG. 7 is a flowchart illustrating a method of transferring DMA data from a plurality of transceivers to a microcontroller, according to an embodiment of the present invention; and

FIG. 8 is a flowchart illustrating a method of transferring DMA data from a microcontroller to a transceiver, according to an embodiment of the present invention.

### DETAILED DESCRIPTION OF THE INVENTION

The present invention will now be described more fully with reference to the accompanying drawings, in which exemplary embodiments of the invention are shown. Like reference numerals denote like elements throughout. While describing the present invention, detailed descriptions of related well known functions or configurations that may obscure the description of the present invention will be omitted. When a portion “includes” a component, it means that other components are not excluded but can be further included unless there is specific description. Terms like “˜ unit”, “—or”, “system”, etc., indicate units for processing at least one function or operation, and may be realized in hardware, software, or in a combination of software and hardware.

A wireless sensor network (WSN) includes a single personal area network (PAN) including a plurality of sensor nodes, a sink node that receives sensing information from one of the sensor nodes, transfers the sensing information to an Internet Protocol (IP) network, and transfers a message from the IP network to a sensor network, and a gateway that performs a protocol conversion function between the IP network and the sensor network. The sink node directly communicates with the sensor nodes included in the PAN via a single channel of a specific RF frequency band.

In this regard, when there is a large number of sensor nodes included in the PAN, a large number of transfer hop is required to transfer the sensing information from a sensor node to the sink node. When the PAN is logically subdivided into a plurality of sub-PANs, the number of transfer hop used to transfer the sensing information from the sensor node to the sink node is reduced, thereby reducing a data transfer delay period and improving reliability of data transfer.

A single sink node simultaneously communicates with the plurality of sub-PANs through different radio frequency (RF) channels via several antennas. In this regard, a microcontroller that performs a medium control function with regard to data received from a plurality of RF transceivers and a conventionally used serial peripheral interface (SPI) bus may render poor data transfer performance.

Therefore, a sink node of the present embodiment uses a direct memory access (DMA) based data transfer method in order to transfer data between the RF transceivers and the microcontroller at high speed, and includes a mediating unit for mediating transfer of the data.

The present invention provides mediation technology for preventing collisions when a sink node transfers data received from each of a plurality of transceivers that connect a plurality of antennas via an SPI bus to a microcontroller, technologies for interfacing the microcontroller and the transceiver based on DMA and transmitting/receiving data, a definition of a frame header used to identify destinations and origins of the data when the microcontroller and the transceivers transmit and receive the data.

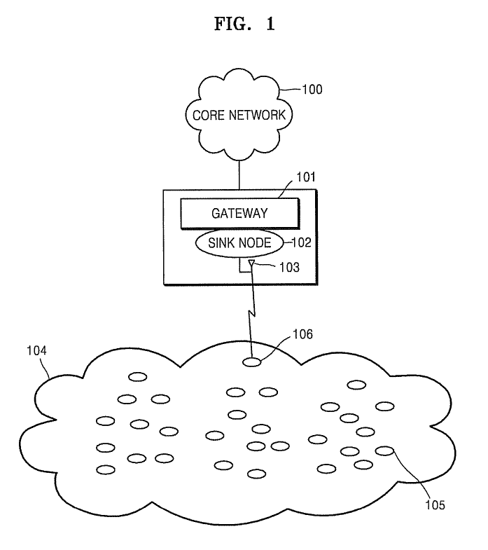

FIG. 1 illustrates a conventional PAN operating structure of a sink node 102 including a single antenna 103. Referring to FIG. 1, a WSN includes a gateway 101, the sink node 102, and a PAN 104 including a plurality of sensor nodes 105. The gateway 101 connects heterogeneous networks between a core network 100 and the PAN 104 and converts protocols according to the connection of heterogeneous networks. The sink node 102 transmits and receives an RF message to and from a subordinate sensor node. When the sink node 102 includes the antenna 103 as used in a conventional sensor network, the antenna 103 communicates with a sensor node 106 through multi-hop communication between the sensor nodes 105 according to a construction topology and routing method of the sensor nodes 105 so that the sensor node 106 may transfer RF sensing information to the core network 100.

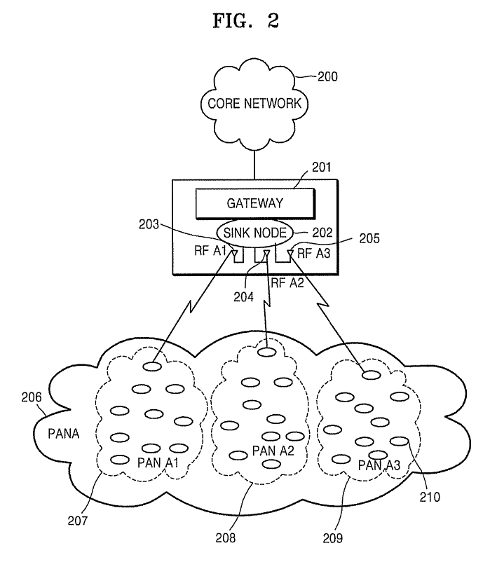

FIG. 2 illustrates a multi-PAN operation structure of a sink node 202 including multiple antennas according to an embodiment of the present invention. Referring to FIG. 2, a WSN includes a big PAN A 206 that is subdivided into a plurality of PANs, a PAN A1 207, a PAN A2 208, and a PAN A3 209. The sink node 202 includes the multiple antennas RF A1 203, RF A2 204, and RF A3 205. The antenna RF A1 203, antenna RF A2 204, and antenna RF A3 205 transmit and receive sensing information to and from the PAN A1 207, PAN A2 208, and PAN A3 209, respectively.

A plurality of sensor nodes included in the PAN A1 207 transmit and receive RF sensing information through multi-hop routing paths between the sensor nodes via the antenna RF A1 203. A plurality of sensor nodes included in the PAN A2 208 and a plurality of sensor nodes included in the PAN A3 209 transmit and receive RF sensing information through multi-hop routing paths between the sensor nodes via the antenna RF A2 204 and the antenna RF A3 205, respectively.

Data is transmitted and received via the different antennas of the sink node 202, thereby reducing the number of routing hop required compared to that necessary for routing from the PAN 104, including all the sensor nodes 105, to the sink node 202 shown in FIG. 1.

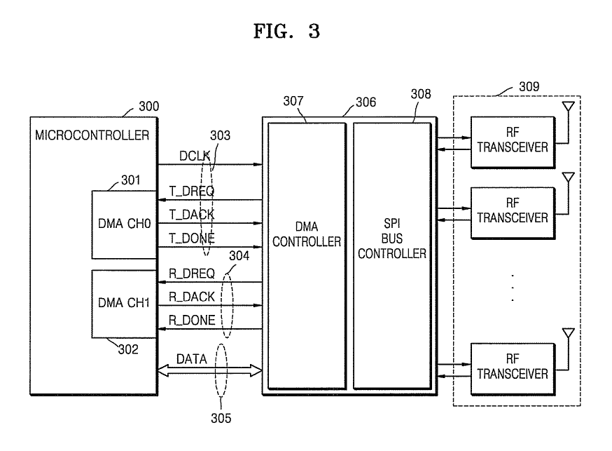

FIG. 3 is a schematic block diagram of an apparatus for transmitting and receiving RF data of a sink node including a plurality of antennas, according to an embodiment of the present invention. Referring to FIG. 3, the apparatus according to the present embodiment includes a microcontroller 300, a multiple transmission and reception controller 306, and a plurality of RF transceivers 309. The multiple transmission and reception controller 306 includes a DMA controller 307 and an SPI bus controller 308.

The sink node performs RF data transmission and reception at high speed through a DMA channel CH0 301 and a DMA channel CH1 302 of the microcontroller 300. In the present embodiment, the DMA channel CH0 301 is used to transmit data, and the DMA channel CH1 302 is used to receive data. Further, the DMA channel CH0 301 may be used to receive data, and the DMA channel CH1 302 may be used to transmit data.

Three signal lines T_DREQ, T_DACK, and T_DONE 303 are used to control DMA transmission. T_DREQ indicates that data transmission from the microcontroller 300 to the DMA controller 307 is requested. T_DACK indicates that a data transmission request is acknowledged. T_DONE indicates that data transmission has been performed. Three signal lines R_DREQ, R_DACK, and R_DONE 304 are used to control DMA reception. R_DREQ indicates that data transmission from the DMA controller 307 to the microcontroller 300 is requested. R_DACK indicates that the data transmission request is acknowledged. R_DONE indicates that the data transmission from the DMA controller 307 to the microcontroller 300 has been performed. A signal line DATA 305 is a parallel data line for transferring data.

The DMA controller 307 performs a DMA control function so as to transfer data at high speed according to the antenna structure of the sink node. The SPI bus controller 308 controls and mediates an SPI signal with regard to receiving data from a plurality of wireless transmission and reception devices interfaced via an SPI bus.

The RF transceivers 309 are independent from each other, and are connected to the antennas The RF transceivers 309 are also connected to the SPI bus controller 308 , which is closely coupled to the DMA controller 307 via the SPI bus so that the RF transceivers 309 are interfaced with the microcontroller 300.

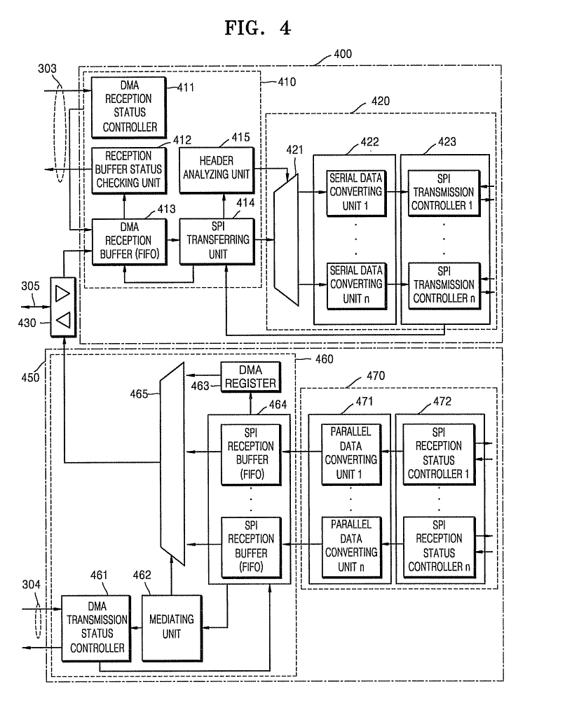

FIG. 4 is a block diagram of the DMA controller 307 and the SPI bus controller 308 that are interfaced with a microcontroller, according to an embodiment of the present invention. Referring to FIG. 4, the DMA controller 307 according to the present embodiment, that is interfaced with the microcontroller includes a DMA reception controller 410 and a DMA transmission controller 460. The SPI bus controller 308 that is interfaced with the microcontroller includes an SPI bus transmission controller 420 and an SPI bus reception controller 470.

A process of transferring data from the microcontroller 300 to a sensor node through one of the transceivers 309 will now be described from the point of view of a transmission side 400 of the DMA controller 307 and the SPI bus controller 308.

The DMA reception controller 410 and the SPI bus transmission controller 420 perform the process of transferring the data. The DMA reception controller 410 includes a DMA reception status controller 411, a reception buffer status checking unit 412, a DMA reception buffer 413, an SPI transferring unit 414, and a header analyzing unit 415. The SPI bus transmission controller 420 includes a transmission path selecting unit 421, a plurality of serial data converting units 422, and a plurality of SPI transmission controllers 423.

The DMA reception status controller 411 checks the status of the DMA reception buffer 413 through the reception buffer status checking unit 412, transmits a signal T_DREQ to the microcontroller, analyzes a signal T_DACK in response to the signal T_DREQ, and stores the data in the DMA reception buffer 413. The DMA reception buffer 413 may be a first-in first-out (FIFO) buffer. A bidirectonal transceiver 430 reads data from the microcontroller 300 through the signal line DATA 305 and outputs the data to the DMA reception buffer 413. If the DMA reception buffer 413 stores the data, the SPI transferring unit 414 transfers the data to the RFI transceiver 309. The header analyzing unit 415 analyzes an address of a DMA destination included in a header of a DMA data frame, selects one of the SPI transmission controllers 423 that is connected to one of the RF transceivers 309 to which the data is transferred among the plurality of RF transceivers 309 through the transmission path selecting unit 421, and performs a transmission control operation. The serial data converting units 422 convert parallel data into serial data and then transfers the serial data to the SPI transmission controllers 423 through the SPI bus.

A process of transmitting the data received from the sensor node to the microcontroller 300 through one of the transceivers 309 will now be described in view of a reception side 450 of the DMA controller 307 and the SPI bus controller 308.

The DMA transmission controller 460 and the SPI bus reception controller 470 perform the process of transferring the data. The DMA transmission controller 460 includes a DMA transmission status controller 461, a mediating unit 462, a DMA register 463, a plurality of SPI reception buffers 464, and a DMA transmission data controller 465. The SPI bus reception controller 470 includes a plurality of parallel data converting units 471 and a plurality of SPI reception controllers 472.

The SPI reception controllers 472 that are interfaced with the RF transceivers 309, respectively, receive serial data according to a control signal received through an SPI bus. The parallel data converting unit 471 converts the serial data into parallel data, and stores the parallel data in the SPI reception buffers 464. The SPI reception buffers 464 may be FIFO buffers. The mediating unit 462 checks statuses of the SPI reception buffers 464 and mediates between the SPI reception buffers 464 that store the parallel data so as to transfer data to the microcontroller 300 based on DMA. The DMA transmission status controller 461 transmits the signal R_DREQ to the microcontroller 300, analyzes the signal R_DACK in response to the signal R_DREQ, and controls the mediating unit 462 to perform a selecting operation and a reading operation with respect to one of the SPI reception buffers 464. In this regard, the mediating unit 462 reads information regarding a destination address and an origin address corresponding to an address of the DMA with regard to the data of the SPI reception buffer 464 selected by the mediating unit 462 and outputs the information to the DMA transmission data controller 465. The DMA transmission data controller 465 outputs a frame, in which address information is added to data, to the bidirectonal transceiver 430. The bidirectonal transceiver 430 transfers the frame to the microcontroller through the data signal line DATA 305.

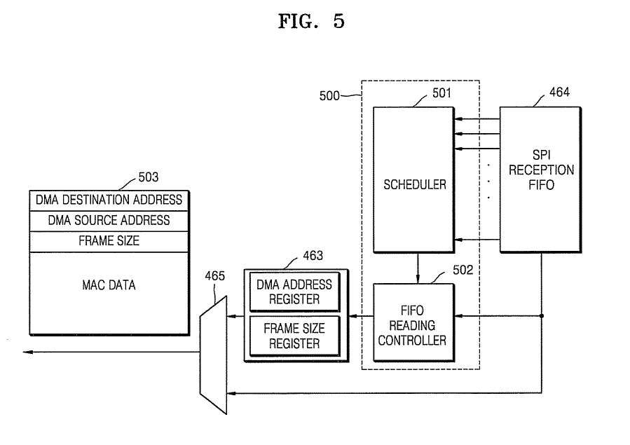

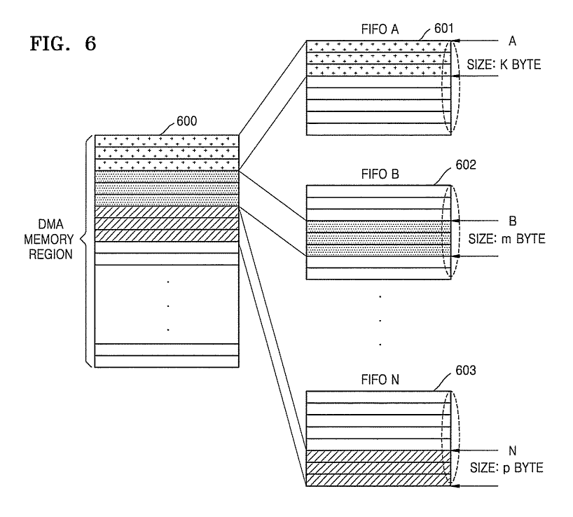

FIG. 5 is a diagram for explaining a mediating method with respect to a status of one of the SPI reception buffers 464 of FIG. 4, according to an embodiment of the present invention. Referring to FIG. 5, a mediating unit 500 mediates data stored in the SPI reception buffers 464 and transfers the data to the microcontroller 300. The mediating unit 500 includes a scheduler 501 and a buffer reading controller 502.

The scheduler 501 checks whether the data received from each RF transceiver 309 is stored in the SPI reception buffer 464 and selects a FIFO buffer to which the data is transferred from the SPI reception buffers 464 in order to mediate between the data received from an SPI bus. The FIFO buffer may be selected using a round robin method or a real time based priority method with respect to data received from a PAN in which real time processing is important. After the scheduler 501 selects the FIFO buffer, the buffer reading controller 502 reads data from the FIFO buffer. The buffer reading controller 502 stores a frame size of corresponding data, a memory start address (DMA destination address) that is to be written in a DMA region of a memory of the microcontroller 300, and an origin address of the FIFO buffer (DMA origin address) in the DMA register 463. The DMA transmission data controller 465 generates a frame 503 that is a combination of content of a header of a frame stored in the DMA register 463 and data (media access control (MAC) data) read from the SPI reception buffers 464 and transfers the frame 503 to the microcontroller 300.

FIG. 6 is a diagram for explaining a memory mapping relationship between a DMA memory 600 and SPI reception buffers 601, 602, and 603, according to an embodiment of the present invention. Referring to FIG. 6, the DMA memory 600 is a region of a memory included in a microcontroller and data having any size (k, m, and p bytes) is stored in each of the SPI reception buffers 601, 602, and 603.

When a scheduler performs a scheduling operation to sequentially mediate data in the SPI reception buffers 601, 602, and 603, the data is sequentially stored in the DMA memory 600. The DMA memory 600 consecutively stores the data based on a destination address of a header of a DMA frame transferred from a FIFO buffer based on DMA, and the size of the DMA frame.

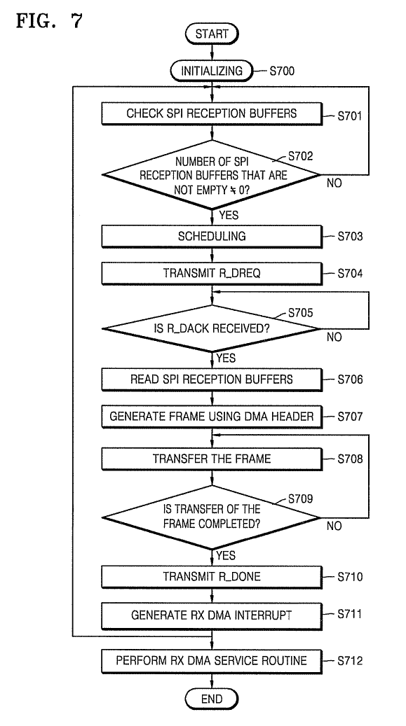

FIG. 7 is a flowchart illustrating a method of transferring DMA data from a plurality of transceivers to a microcontroller, according to an embodiment of the present invention. Referring to FIG. 7, in operation 700, a DMA controller and an SPI bus controller are initialized.

In operation 701, a scheduler checks an SPI reception buffer in order to perform a mediation operation with regard to sensing data received from the transceivers, and in operation 702, the scheduler determines whether the number of FIFO buffers that are not empty is 0.

If it is determined that the number of FIFO buffers that are not empty is not 0, in operation 703, a FIFO buffer that is to be scheduled is determined according to a round robin policy or a real time based priority policy.

In operation 704, the DMA controller transmits a DMA transfer request signal R DREQ in order to transfer data to the microcontroller.

In operation 705, it is determined whether an ACK signal R_DACK indicating that a request for data transfer is acknowledged is transmitted. If it is determined that the ACK signal R_DACK is received from the microcontroller, in operation 706, data is read from the SPI reception buffer.

In operation 707, a header, including DMA destination origin addresses stored in a DMA register, and frame size information of a frame that is to be transferred, is encapsulated in data, and thus a frame including the header is generated.

In operation 708, the frame is transferred to the microcontroller according to a DMA transfer sync clock.

In operation 709, it is determined whether the frame is completely transferred. If it is determined that the frame is completely transferred, in operation 710, an complete signal R_DONE is driven.

In operation 711, a DMA reception interrupt is generated. In operation 712, the microcontroller performs a service routine operation with regard to the DMA reception interrupt.

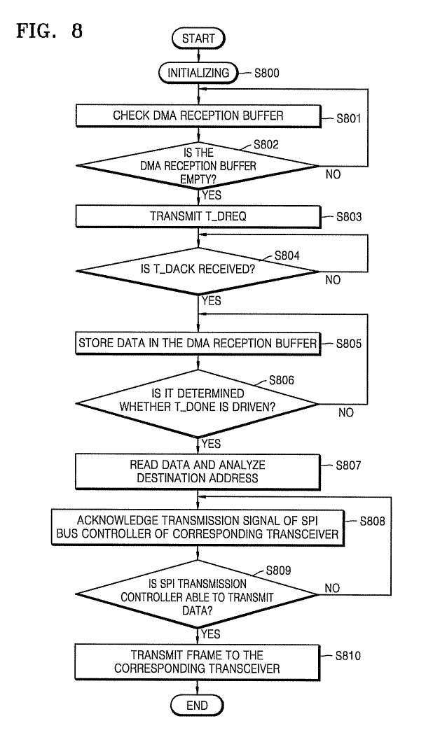

FIG. 8 is a flowchart illustrating a method of transferring DMA data from a microcontroller to a transceiver, according to an embodiment of the present invention. Referring to FIG. 8, in operation 800, a DMA controller and an SPI bus controller are initialized.

In operation 801, a reception buffer status checking unit checks a DMA reception buffer, and, in operation 802, determines whether the DMA reception buffer is empty.

In operation 803, the DMA controller transmits a DMA transfer request signal T_DREQ in order to receive the data from the microcontroller.

In operation 804, it is determined whether an ACK signal T_DACK indicating that a request for data transfer is acknowledged is transmitted. If it is determined that the ACK signal T_DACK is received from the microcontroller, in operation 805, the data is stored in the SPI reception buffer.

In operation 806, it is determined whether a data transfer complete signal T_DONE is transmitted from the microcontroller. If it is determined that the data transfer complete signal T_DONE is transmitted, in operation 807, all of the data is stored in the DMA reception buffer, and a destination address of the data stored in the DMA reception buffer is analyzed.

In operation 808, a transmission signal of the SPI bus controller of a transceiver corresponding to the analyzed destination address is determined. In operation 809, it is determined if an SPI transmission controller can transmit the data.

If it is determined that the SPI transmission controller can transmit the data, in operation 810, the frame is transmitted to the transceiver.

A single sink node having multiple antennas includes a plurality of RF transceivers and is interfaced with a microcontroller in order to operate a multi-PAN in a WSN. Conventionally, when the single sink node includes a single antenna, a single transceiver and the microcontroller are directly connected to each other via SPI interfacing, whereas when the sink node includes multiple tranceivers mediation is needed to transfer data between the microcontroller and the plurality of RF transceivers and fast interfacing is needed to remove a bottleneck that occurs when transferring the data. Thus, the present invention provides a DMA based data transfer method and a sink node including a data mediator in order to transfer data at high speed between the microcontroller and transceivers. The data mediator may use separate DMA channels to transmit and receive data between the microcontroller and transceivers, thereby increasing transfer performance.

According to another embodiment, instead of a computer software command for implementing the present invention, a programmed processor/controller or hardware formed by a combination of the programmed processor/controller may be used. Therefore, the present invention is not limited by a particular combination of hardware and software.

In the present invention, a sink node uses a plurality of antennas and operates a plurality of small sub-PANs included in a single large PAN in a WSN including a plurality of sensor nodes, thereby reducing the number of data transfer hop from the sensor nodes to the sink node and reducing a data transfer delay.

Also, a plurality of transceivers of the sink node that are connected via an SPI bus performs a meditation function, and a DMA based method is used to transfer data to the microcontroller, thereby removing a bottleneck of data transfer.

In addition, a data transfer is mediated according to real-time service priority based scheduling, thereby transferring data in real-time.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A direct memory access (DMA) based data transmitting and receiving apparatus of a sink node, the apparatus comprising:
a serial peripheral interface (SPI) bus controller controlling receiving, through a plurality of transceivers, data from each of a plurality of sub networks included in a sensor network; and
a DMA controller storing the received data and scheduling the stored data to a microcontroller according to a determined order.

2. The apparatus of claim 1, wherein the DMA controller comprises:
a plurality of buffers storing the received data according to the plurality of transceivers;
a mediating unit mediating transfer of the data stored in the plurality of buffers; and
a data controller generating a frame by encapsulating a header comprising origin and destination addresses and frame size information in the received data and outputting the frame.

3. The apparatus of claim 1, wherein the SPI bus controller comprises:
an SPI bus reception controller serially receiving the data through the plurality of transceivers; and
a parallel data converting unit converting the serial data into parallel data.

4. The apparatus of claim 2, wherein the mediating unit comprises:
a scheduler determining whether the data is stored in the plurality of buffers and selecting one of the plurality of buffers according to the determined order; and
a buffer reading controller reading the data stored in the selected buffer and storing a frame size and origin and destination addresses of the read data in a DMA register.

5. A direct memory access (DMA) based data transmitting and receiving apparatus of a sink node, the apparatus comprising:
a DMA controller storing data received from a microcontroller and scheduling the stored data to a plurality of transceivers that communicate with a sensor network that is divided into a plurality of sub networks; and
an serial peripheral interface (SPI) bus controller controlling the scheduled data to be transmitted to one of the plurality of transceivers.

6. The apparatus of claim 5, wherein the DMA controller comprises:
a buffer storing the data received from the microcontroller;
a data transferring unit determining whether the data is stored in the buffer and reading and outputting the data stored in the buffer; and
a header analyzing unit analyzing a destination address of the output data.

7. The apparatus of claim 5, wherein the SPI bus controller comprises:
a serial data converting unit converting the data, which is parallel data, into serial data; and
an SPI bus transmission controller transmitting the serial data to a corresponding transceiver of the plurality of transceivers based on a destination address of the data.

8. A direct memory access (DMA) based data transmitting and receiving apparatus of a sink node, the sink node comprising:
a receiving unit storing data received, through a plurality of transceivers, from each of a plurality of sub networks of a sensor network and scheduling the data to a microcontroller; and
a transmitting unit storing data received from the microcontroller and scheduling the data to a corresponding transceiver of the plurality of transceivers.

9. The apparatus of claim 8, wherein the receiving unit comprises:
a bus controller controlling receiving of the data; and
a DMA controller scheduling the received data to the microcontroller according to a determined order.

10. The apparatus of claim 8, wherein the transmitting unit comprises:
a DMA controller scheduling the data received from the microcontroller to the plurality of transceivers; and
a SPI bus controller controlling the data to be transmitted to one of the plurality of transceivers.

11. A direct memory access (DMA) based data transmitting and receiving apparatus of a sink node, the apparatus comprising:
an serial peripheral interface (SPI) bus controller interfaced with a plurality of transceivers communicating, via an SPI bus, with a plurality of sub networks included in a sensor network including a plurality of sensor nodes and controlling transmitting and receiving of data through the plurality of transceivers according to a bus control signal; and
a DMA controller storing data received from the plurality of sub networks, scheduling the stored data to a microcontroller, storing data received from the microcontroller, and scheduling the stored data to the plurality of transceivers.

12. The apparatus of claim 11, wherein the DMA controller comprises: a mediating unit selecting the data stored according to the plurality of transceivers according to a determined order, reading data stored in a selected buffer, and storing a frame size and origin and destination addresses of the read data in a DMA register.

13. A direct memory access (DMA) based data transferring method performed by a sink node, the method comprising:
receiving, through a plurality of transceivers, data from each of a plurality of sub networks include in a sensor network; and
storing the received data and scheduling the stored data to a microcontroller according to a determined order.

14. The method of claim 13, wherein the scheduling comprises:
checking statuses of a plurality of buffers storing the received data according to the plurality of transceivers;
reading data stored in one of the buffers selected according to the determined order; and
generating a frame by encapsulating a header comprising origin and destination addresses and frame size information in the read data and outputting the frame.

15. The method of claim 13, further comprising: storing the scheduled data at a corresponding address of a memory of a microcontroller based on a destination address and frame size of the stored data.

16. The method of claim 13, wherein the scheduling comprises:
if data to be scheduled is determined, requesting the data to be transferred to the microcontroller;
acquiring acknowledgement of transfer of the data from the microcontroller; and
if the data is completely scheduled, informing the microcontroller that transfer of the data is completed.

17. A direct memory access (DMA) based data transferring method performed by a sink node, the method comprising:
storing data received from a microcontroller and scheduling the stored data to a plurality of transceivers that communicate with a sensor network that is divided into a plurality of sub networks; and
controlling the scheduled data to be transmitted to one of the plurality of transceivers.

18. The method of claim 17, wherein the scheduling comprises:
determining whether the data received from the microcontroller is stored in a buffer; and
outputting the data stored in the buffer and a destination address of the data.

19. The method of claim 17, wherein the scheduling comprises:
requesting the data to be transferred to the microcontroller;
acquiring an acknowledgement of transfer of the data from the microcontroller; and
receiving a signal from the microcontroller indicating that transfer of the data is completed.
